(19) United States
(12) Patent Application Publication
(10) Pub. No.: US 2026/0336190 A1
(43) Pub. Date: Oct. 29, 2026

(54) DISCHARGE DEVICE AND DISCHARGE METHOD

(71) Applicant: Panasonic Intellectual Property Management Co., Ltd., Osaka (JP)

(72) Inventors: AYA KUROKAWA, Osaka (JP); DAISUKE SAKURAI, Osaka (JP); KIYOKAZU ITOI, Osaka (JP); TAKAHIRO KUMAKAWA, Kyoto (JP)

(21) Appl. No.: 19/700,348

(22) Filed: Jun. 7, 2026

Related U.S. Application Data
(63) Continuation of application No. PCT/JP2024/040266, filed on Nov. 13, 2024.

(30) Foreign Application Priority Data
Dec. 20, 2023 (JP) 2023-214937

(51) Int. Cl. B29C 48/86; B29C 35/08; B29C 48/08; B29C 48/154; B29L 11/00

(52) U.S. Cl. CPC B29C 48/865; B29C 35/0805; B29C 48/08; B29C 48/154; B29L 2011/0075

(57) ABSTRACT

Discharge device (1) includes housing (10) in which photocurable material (M) is housed, light source (30) that emits light (L), and lens (40) that collects light (L) emitted from light source (30).

### TECHNICAL FIELD

The present disclosure relates to a discharge device and a discharge method.

### BACKGROUND ART

Various techniques are disclosed for a discharge device for discharging a photocurable material. For example, a discharge device according to PTL 1 includes a nozzle that discharges a photocurable material, and a light source that irradiates the photocurable material discharged from the nozzle with light. A light shielding member that shields emitted light is disposed at a portion facing the light source around the nozzle.

### CITATION LIST

### Patent Literature

PTL 1: Unexamined Japanese Patent Publication No. 2009-166008

### SUMMARY OF THE INVENTION

For example, in the discharge device according to PTL 1, in a case where the photocurable material is three-dimensionally discharged from the nozzle to an object (substrate or the like), when the nozzle is brought close to the object, since the photocurable material discharged from the nozzle to the object comes into contact with the light shielding member disposed around the nozzle, as a result, the photocurable material is distorted and cured in a non-uniform shape.

As described above, the discharge device of the related art has a problem that the discharged photocurable material is unevenly cured.

The present disclosure has been made in view of such a point, and an object thereof is to stably cure a photocurable material.

A discharge device according to the present disclosure includes a housing in which a photocurable material is housed, a light source that emits light, and a lens that focuses the light emitted from the light source, in which a nozzle through which the photocurable material is discharged is provided in the housing, the photocurable material housed in the housing is disposed between the light source and the nozzle, and the light emitted from the light source is focused by the lens, passes through the photocurable material housed in the housing, and is emitted from the nozzle.

The discharge method according to the present disclosure emits, by using the discharge device, the light from the nozzle through the photocurable material housed in the housing while focusing the light with the lens while discharging the photocurable material from the nozzle.

According to the present disclosure, the photocurable material can be stably cured.

### BRIEF DESCRIPTION OF THE DRAWINGS

FIG. 1 illustrates a discharge device according to a first exemplary embodiment.

FIG. 2 illustrates a discharge device according to a second exemplary embodiment.

FIG. 3 illustrates a discharge device according to a third exemplary embodiment.

FIG. 4 illustrates a discharge method according to a fourth exemplary embodiment.

### DESCRIPTION OF EMBODIMENT

Exemplary embodiments of the present disclosure will be described below in detail with reference to the drawings. The following description of preferred exemplary embodiments is merely illustrative in nature and is not intended to limit the present disclosure, applications thereof, or uses thereof at all.

### First Exemplary Embodiment

(Discharge device)

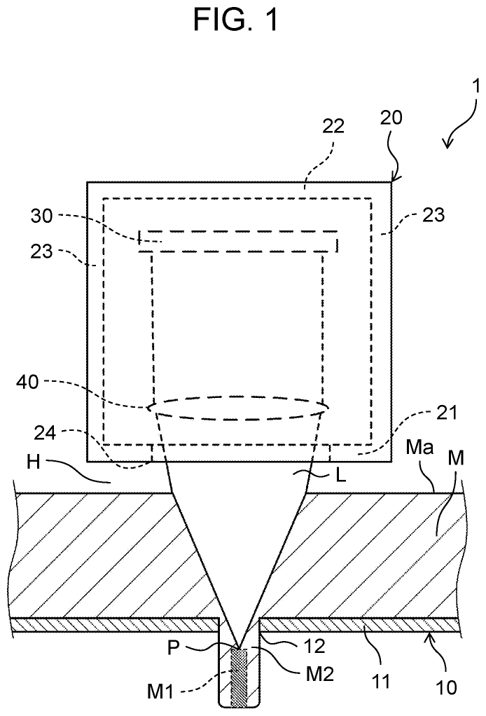

Discharge device 1 according to a first exemplary embodiment will be described. FIG. 1 is a front view of discharge device 1 (with a part in section). Discharge device 1 is movable by a moving mechanism (not illustrated). Discharge device 1 includes housing 10, light emission head 20, light source 30, and lens 40.

Housing 10 is formed into, for example, a box shape opening upward. Housing 10 includes lower wall 11 extending horizontally and side wall (not illustrated) rising upward from an edge of lower wall 11. Housing 10 forms an internal space surrounded by lower wall 11 and the side wall. Lower wall 11 and the side wall define the internal space of housing 10 and an external space of housing 10.

Nozzle 12 is provided in lower wall 11 of housing 10. Nozzle 12 vertically penetrates lower wall 11. Nozzle 12 allows the internal space of housing 10 and the external space of housing 10 to communicate with each other. Nozzle 12 is also referred to as a discharge nozzle. A shape of housing 10 can be voluntarily changed. For example, lower wall 11 may be inclined toward nozzle 12.

Photocurable resin M as a photocurable material is housed in housing 10. In other words, housing 10 is filled with photocurable resin M. Photocurable resin M is housed in the internal space surrounded by lower wall 11 and the side wall in housing 10. Photocurable resin M is in a state of being placed on an inner surface (upper surface) of lower wall 11 of housing 10.

Photocurable resin M is a resin that is cured by light of a specific wavelength (changes from a liquid to an individual). Photocurable resin M is a liquid in a state of being housed in housing 10. As will be described later, photocurable resin M is appropriately set to correspond to a wavelength of light L from light source 30.

Liquid level Ma of photocurable resin M housed in the internal space of housing 10 faces upward. Liquid level Ma of photocurable resin M can also be said to be an upper surface of photocurable resin M.

Photocurable resin M housed in the internal space of housing 10 is discharged downward to the external space of housing 10 via nozzle 12 provided in lower wall 11 of housing 10. light emission head 20 is formed into, for example, a box shape. light emission head 20 includes lower wall 21 extending horizontally, upper wall 22 extending horizontally and disposed above lower wall 21, and side walls 23 vertically coupling an edge of lower wall 21 and an edge of upper wall 22.

Lower wall 21 of light emission head 20 is provided with emission port 24. Emission port 24 optically penetrates lower wall 21 vertically. Emission port 24 communicates an inside and an outside of light emission head 20. Emission port 24 provided in lower wall 21 of light emission head 20 is disposed above nozzle 12 of lower wall 11 of housing 10 (further, is disposed above liquid level Ma of photocurable resin M housed in housing 10). Emission port 24 faces liquid level Ma of photocurable resin M housed in housing 10.

Gap H is provided between emission port 24 of lower wall 21 of light emission head 20 and liquid level Ma of photocurable resin M housed in housing 10. An air layer (air gap) is formed in gap H.

Light source 30 and lens 40 are housed in light emission head 20. Specifically, light source 30 and lens 40 are housed in an internal space surrounded by lower wall 21, upper wall 22, and side walls 23 in light emission head 20. Light source 30 and lens 40 housed in light emission head 20 are disposed above nozzle 12 of lower wall 11 of housing 10 (further, are disposed above liquid level Ma of photocurable resin M housed in housing 10). A device (for example, a laser oscillator) that converts electricity into light is used as light source 30. In addition, light source 30 may be provided outside light emission head 20, and the light generated from light source 30 may be propagated to light emission head 20 by an optical fiber or the like.

Photocurable resin M housed in housing 10 is disposed between light source 30 and nozzle 12 of housing 10 in an upper-lower direction.

Light source 30 emits light L. Light L is, for example, laser light. Light source 30 is, for example, a laser oscillator or the like. Note that, “light” is understood in a broad sense, and is not limited to visible light, and includes the entire electromagnetic wave so as to include other wavelength regions such as ultraviolet rays and infrared rays. Light L is preferably an ultraviolet ray or an infrared ray.

In light emission head 20, light source 30 is disposed above lens 40. Light source 30 faces emission port 24 via lens 40.

Lens 40 focuses light L emitted from light source 30. In other words, lens 40 converges light L emitted from light source 30. Lens 40 is, for example, a convex lens. In light emission head 20, lens 40 is disposed below light source 30. Lens 40 is disposed between light source 30 and emission port 24. Lens 40 faces emission port 24.

In light emission head 20, light L emitted from light source 30 is focused by lens 40 and emitted downward through emission port 24. Light L emitted downward from emission port 24 of light emission head 20 passes through photocurable resin M housed in housing 10 and is emitted downward from nozzle 12 of lower wall 11 of housing 10.

In summary, light L emitted from light source 30 is focused by lens 40, passes through photocurable resin M housed in housing 10, and is emitted from nozzle 12.

Focal point P of light L by lens 40 is positioned below nozzle 12 of lower wall 11 of housing 10. In other words, focal point P is positioned in the external space of housing 10. Focal point P is also referred to as a focal point. Focal point P is a point where light beams of light L incident on lens 40 from light source 30 are concentrated.

On the other hand, as described above, light source 30 is positioned above nozzle 12 of lower wall 11 of housing 10. That is, focal point P of light L by lens 40 is positioned on a side opposite to light source 30 with respect to nozzle 12 of lower wall 11 of housing 10 in the upper-lower direction. Focal point P is positioned at the same position as a center of nozzle 12 in a horizontal direction. Focal point P faces nozzle 12.

### (Discharge Method)

A discharge method using discharge device 1 will be described. In the present discharge method, due to the use of discharge device 1, light L from light source 30 is emitted from nozzle 12 through photocurable resin M housed in housing 10 while being focused by lens 40 while discharging photocurable resin M from nozzle 12.

In the present discharge method, photocurable resin M is cured (becomes solid from liquid) by multi-photon absorption of light L at focal point P by lens 40. The curing of photocurable resin M occurs only at focal point P positioned below nozzle 12 of lower wall 11 of housing 10 (in the external space of housing 10). The curing of photocurable resin M does not occur in the internal space above lower wall 11 in housing 10. Only photocurable resin M immediately after being discharged from nozzle 12 is cured by the multi-photon absorption of light L at focal point P.

The multi-photon absorption is a phenomenon in which two or more (many) photons are simultaneously absorbed. Light L having a large photon density is generated by a method such as focusing (converging) light L (preferably laser light) with lens 40, and thus, two or more (many) photons are simultaneously absorbed. As an example of the multi-photon absorption, a phenomenon in which two photons are simultaneously absorbed is referred to as two-photon absorption.

For example, it is assumed that a material suitably cured by light L of a high-energy ultraviolet ray (for example, known ultraviolet curing resin, acrylic resin, epoxy resin, and the like) is selected as photocurable resin M. Photocurable resin M corresponding to the ultraviolet ray is not cured by simply applying light L of a low-energy infrared ray to photocurable resin M corresponding to the high-energy ultraviolet ray.

However, even with light L of the low-energy infrared ray, light L is focused by lens 40 to increase an energy density, and thus, photocurable resin M corresponding to the high-energy ultraviolet ray can be cured by the multi-photon absorption of light L.

In the present discharge method, photocurable resin M is cured by the multi-photon absorption of light L focused by lens 40 by photocurable resin M only at focal point P positioned below nozzle 12 of lower wall 11 of housing 10. On the other hand, in the present discharge method, photocurable resin M is not cured in the internal space above lower wall 11 in housing 10 since light L is not multi-photon absorbed by photocurable resin M. That is, photocurable resin M before discharge housed in housing 10 is not cured.

In order to cure photocurable resin M only at focal point P by the multi-photon absorption, a wavelength of light L and a material of photocurable resin M need to be appropriately selected.

Photocurable resin M is preferably made of a material through which light L is transmitted in order to suppress reflection of light L. For example, in a case where the wavelength of light L is 500 nm to 1500 nm, the material of photocurable resin M preferably transmits light L having a wavelength of 500 nm to 1500 nm and further absorbs light L of 200 nm to 450 nm.

A multi-photon absorbing material (for example, BTP-1 or IB-3) is preferably applied as photocurable resin M. Photocurable resin M is preferably a combined curing type with light L and heat.

A diameter of nozzle 12 is, for example, preferably 20 μm to 250 μm.

A viscosity of photocurable resin M is preferably about 3000 mPa·s to 6000 mPa·s.

In the present discharge method, photocurable resin M discharged from nozzle 12 of housing 10 is cured at a central portion (in the horizontal direction) at focal point P to become cured resin portion M1, and is uncured to become uncured resin portion M2 without being cured at an outer peripheral portion (on an outer peripheral side of the central portion in the horizontal direction). Note that, since photocurable resin M housed in housing 10 is uncured, the photocurable resin M is uncured resin portion M2.

Cured photocurable resin M is applied to, for example, surface bonding of a liquid crystal panel, local adhesion of an electronic component, a gasket, or the like. (Operation and effect)

According to discharge device 1 of the present exemplary embodiment, light L emitted from light source 30 is focused by lens 40, passes through photocurable resin M housed in housing 10, and is emitted from nozzle 12 of housing 10. According to the discharge method according to the present exemplary embodiment, light L is emitted from nozzle 12 of housing 10 through photocurable resin M housed in housing 10 while being focused by lens 40 while discharging photocurable resin M from nozzle 12 of housing 10.

Since light L focused by lens 40 is applied to photocurable resin M near nozzle 12, photocurable resin M is concentrated and cured at a timing of being discharged from nozzle 12.

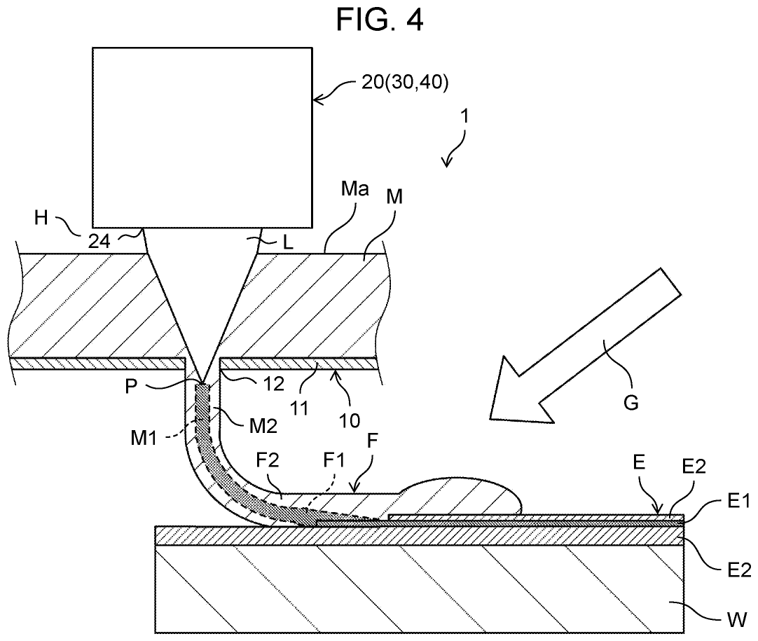

For example, in discharge device 1 according to the present exemplary embodiment, it is not necessary to dispose a light shielding member around nozzle 12. Thus, in a case where photocurable resin M is three-dimensionally discharged from nozzle 12 to an object (for example, substrate W or the like, see, FIG. 4), it is possible to suppress photocurable resin M discharged from nozzle 12 to the object from coming into contact with the light shielding member.

As a result, it is possible to prevent photocurable resin M discharged from nozzle 12 from being distorted and cured in a non-uniform shape. Even in a case where photocurable resin M is three-dimensionally discharged from nozzle 12 to the object, photocurable resin M can be cured in a uniform shape by concentrating and curing photocurable resin M near nozzle 12 (preferably, only focal point P).

In addition, photocurable resin M is concentrated and cured near nozzle 12 (preferably, only focal point P), and thus, irregular reflection from the object (for example, substrate W or the like, see, FIG. 4) is suppressed. As a result, photocurable resin M can be cured in a uniform shape.

In addition, it is possible to suppress the occurrence of a difference in an irradiation time of light L between photocurable resin M immediately after being discharged from nozzle 12 and photocurable resin M after a lapse of some time after being discharged from nozzle 12. As a result, a difference in a degree of curing between photocurable resin M immediately after being discharged from nozzle 12 and photocurable resin M after some time has elapsed after being discharged from nozzle 12 is suppressed. As a result, photocurable resin M can be cured in a uniform shape.

As described above, in discharge device 1 according to the present exemplary embodiment, the shape of cured photocurable resin M is suppressed from becoming unstable (non-uniform). As described above, according to discharge device 1 and the discharge method according to the present exemplary embodiment, photocurable resin M can be stably (uniformly) cured.

Focal point P of light L by lens 40 is positioned on the side opposite to light source 30 with respect to nozzle 12 of housing 10. Light L immediately after being discharged from nozzle 12 of housing 10 can be concentrated and cured at focal point P.

Since nozzle 12 is provided in lower wall 11 of housing 10 and light source 30 is disposed above nozzle 12 of lower wall 11 of housing 10, photocurable resin M can be smoothly discharged from nozzle 12 by gravity, and handling of discharge device 1 becomes easy.

According to the principle of the multi-photon absorption, photocurable resin M can be cured only at focal point P, and photocurable resin M can be prevented from being cured at a point other than focal point P.

Since the curing of photocurable resin M at a point other than focal point P is suppressed by concentrating and curing photocurable resin M only at focal point P, clogging of photocurable resin M without being cured at a tip of nozzle 12 can be suppressed.

### Second Exemplary Embodiment

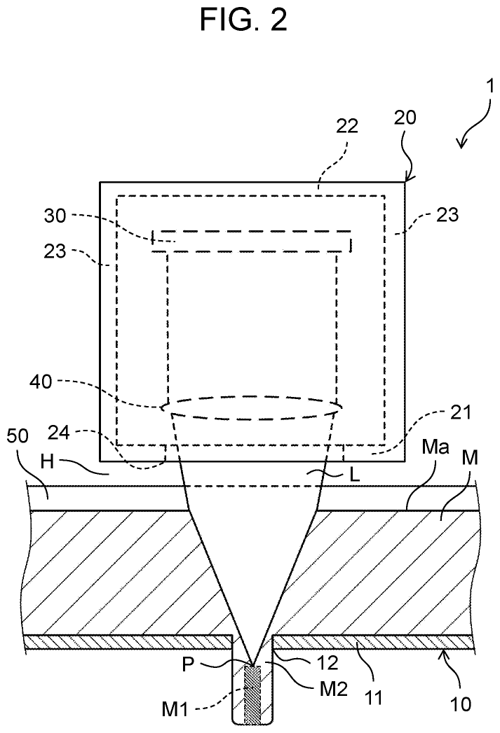

Discharge device 1 according to a second exemplary embodiment will be described. In the following description, configurations similar to those of the above exemplary embodiment are denoted by the same reference marks, and may not be described in detail. FIG. 2 is a front view of discharge device 1 (with a part in section).

Liquid level Ma of photocurable resin M housed in housing 10 faces emission port 24 of the upper light emission head 20 present above. Transmissive material 50 is disposed between emission port 24 of light L in lower wall 21 of light emission head 20 and liquid level Ma of photocurable resin M housed in housing 10. Transmissive material 50 is disposed below emission port 24 of lower wall 21 of light emission head 20 and above liquid level Ma of photocurable resin M housed in housing 10.

Transmissive material 50 has a plate shape whose thickness direction is the upper-lower direction, and extends in the horizontal direction. Transmissive material 50 transmits light L. Transmissive material 50 is made of, for example, transparent glass or transparent plastic. A lower surface of transmissive material 50 covers liquid level Ma in photocurable resin M housed in housing 10 facing emission port 24 of light emission head 20.

Gap H is provided between a lower surface of lower wall 21 of light emission head 20 and an upper surface of transmissive material 50.

Other configurations are similar to those of the first exemplary embodiment.

In a case where there is no transmissive material 50, unevenness occurs on liquid level Ma of photocurable resin M stored in housing 10. When liquid level Ma of photocurable resin M is uneven, a refractive index of light L is disturbed and becomes unstable, and focal point P by lens 40 deviates in position and becomes unstable.

According to the present exemplary embodiment, liquid level Ma of photocurable resin M housed in housing 10 is covered with transmissive material 50, and thus, it is possible to suppress the occurrence of unevenness in liquid level Ma of photocurable resin M (liquid level Ma can be made flat). As a result, the refractive index of light L is stabilized, and thus, focal point P by lens 40 can be stabilized. As a result, the positional deviation of focal point P can be suppressed.

The positional deviation of focal point P is suppressed, and thus, photocurable resin M can be stably cured.

### Third Exemplary Embodiment

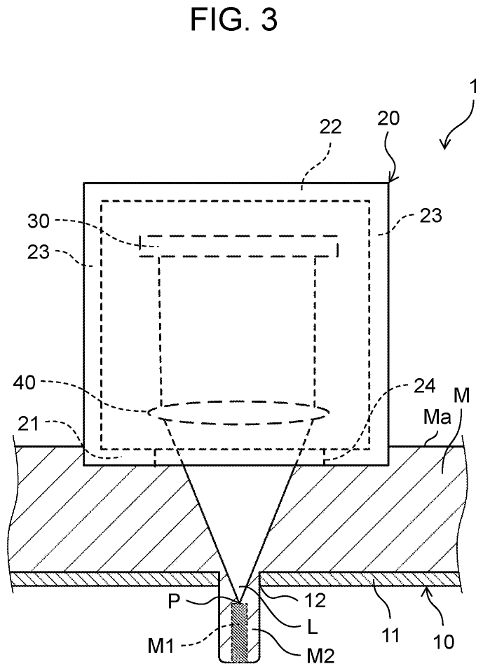

Discharge device 1 according to a third exemplary embodiment will be described. In the following description, configurations similar to those of the above exemplary embodiment are denoted by the same reference marks, and may not be described in detail. FIG. 3 is a front view of discharge device 1 according to the third exemplary embodiment (with a part in section).

Emission port 24 of light L in lower wall 21 of light emission head 20 is disposed below liquid level Ma of photocurable resin M housed in housing 10. Emission port 24 of light L in lower wall 21 of light emission head 20 is immersed in photocurable resin M housed in housing 10 from above.

There is no gap H (air gap, see FIG. 1) between emission port 24 of lower wall 21 of light emission head 20 and liquid level Ma of photocurable resin M housed in housing 10.

Other configurations are similar to those of the first exemplary embodiment and the second exemplary embodiment.

According to the present exemplary embodiment, gap H (air gap) can be suppressed from being formed between emission port 24 of light emission head 20 and liquid level Ma of photocurable resin M by immersing emission port 24 of light emission head 20 in photocurable resin M.

It is possible to suppress the refractive index of light L emitted from emission port 24 of light emission head 20 from being changed and disturbed between gap H (air gap) and photocurable resin M. The refractive index of light L is stabilized, and thus, focal point P by lens 40 can be stabilized. As a result, the positional deviation of focal point P can be suppressed.

The positional deviation of focal point P is suppressed, and thus, photocurable resin M can be stably cured.

### Fourth Exemplary Embodiment

A discharge method according to a fourth exemplary embodiment will be described. In the following description, configurations similar to those of the above exemplary embodiment are denoted by the same reference marks, and may not be described in detail. FIG. 4 is a front view illustrating a discharge method using discharge device 1 (with a part in section).

Substrate W is disposed on a stage (not illustrated). Substrate W is, for example, a semiconductor substrate. Substrate W extends in the horizontal direction with the upper-lower direction as the thickness direction. An upper surface of substrate W faces discharge hole 12 of lower wall 11 of housing 10. Optical waveguide E is formed on the upper surface of substrate W. Optical waveguide E is a transmission line that uses light for communication and is generated by a substance having optical characteristics. Optical waveguide E includes core E1 and cladding E2. For example, various semiconductor materials and the like can be applied as optical waveguide E.

Optical waveguide E covers the upper surface of substrate W. In optical waveguide E, core E1 is embedded inside cladding E2. In other words, in optical waveguide E, an outer periphery of core E1 is covered with cladding E2. At an end portion of substrate W (a left end portion in FIG. 4), a part of cladding E2 (an upper portion in FIG. 4) is removed, and core E1 is exposed.

In the present discharge method, optical transmission line F is formed on substrate W by photocurable resin M discharged from nozzle 12 of housing 10. Optical transmission line F is a transmission line of light. An example of optical transmission line F is an optical fiber. Optical transmission line F is essentially the same type as optical waveguide E. Optical transmission line F includes core F1 and cladding F2.

As described above, at focal point P, photocurable resin M discharged from nozzle 12 of housing 10 is cured at the central portion to become cured resin portion M1, and is uncured without being cured at the outer peripheral portion to become uncured resin portion M2.

Photocurable resin M discharged from nozzle 12 of housing 10 is applied to substrate W so as to be connected to a break (a portion where core E1 is exposed) of optical waveguide E. Cured resin portion M1 at the central portion of discharged photocurable resin M corresponds to core F1 of optical transmission line F. Uncured resin portion M2 of the outer peripheral portion of discharged photocurable resin M corresponds to cladding F2 of optical transmission line F.

Cured resin portion M1 at the central portion of photocurable resin M is connected to core E1 of optical waveguide E on substrate W to become core F1 of optical transmission line F. Uncured resin portion M2 on the outer peripheral portion of photocurable resin M is connected to cladding E2 of optical waveguide E on substrate W, and becomes cladding F2 of optical transmission line F after being cured as described later.

Uncured resin portion M2 of photocurable resin M connected to cladding E2 of optical waveguide E on substrate W is cured by external light G applied from obliquely upper sideways, and becomes cladding F2 of optical transmission line F. A wavelength of external light G is preferably different from the wavelength of light L from light source 30. Heat may be used instead of external light G.

One optical waveguide E and another optical waveguide E may be connected to each other via optical transmission line F. Optical waveguide E may be connected to an external optical fiber or the like via optical transmission line F.

Other configurations are similar to those of the first exemplary embodiment.

According to the present exemplary embodiment, optical transmission line F can be suitably formed on substrate W by using discharge device 1.

### Other Exemplary Embodiments

Although the present disclosure has been described with reference to suitable exemplary embodiments, the present disclosure is not limited to the above description, and various modifications, substitutions, or combinations can be surely made.

Light source 30 and lens 40 may be disposed separately from each other instead of being housed in light emission head 20. For example, lens 40 may be disposed outside light emission head 20.

Focal point P of light L by lens 40 may be positioned not in the external space but in the internal space of housing 10.

Light L is not limited to laser light. The wavelength of light L is not limited to the exemplified numerical values. Photocurable material M is not limited to those exemplified (may not be a resin depending on conditions). Transmissive material 50 is not limited to those illustrated.

The principle of the multi-photon absorption may not necessarily be used.

For example, nozzle 12 may be provided in the side wall of housing 10, and light source 30 may be disposed laterally of nozzle 12 in the side wall of housing 10.

The present disclosure does not prevent discharge device 1 from including the light shielding member. Discharge device 1 may include the light shielding member.

The discharge method using discharge device 1 is not limited to the exemplified method, and various applications are conceivable.

### INDUSTRIAL APPLICABILITY

Since the present disclosure can be applied to a discharge device and a discharge method, the present disclosure is extremely useful and has high industrial applicability.

### REFERENCE MARKS IN THE DRAWINGS

M photocurable resin (photocurable material)
Ma liquid level (surface)
M1 cured resin portion
M2 uncured resin portion
L light
P focal point
H gap
W substrate
E optical waveguide
E1 core
E2 cladding
F optical transmission line
F1 core
F2 cladding
G external light
1 discharge device
10 housing
11 lower wall
12 nozzle
20 light emission head
21 lower wall
22 upper wall
23 side wall
24 emission port
30 light source
40 lens
50 transmissive material

1. A discharge device comprising:
a housing in which a photocurable material is housed;
a light source that emits light; and
a lens that focuses the light emitted from the light source,
wherein
a nozzle through which the photocurable material is discharged is provided in the housing,
the photocurable material housed in the housing is disposed between the light source and the nozzle, and
the light emitted from the light source is focused by the lens, passes through the photocurable material housed in the housing, and is emitted from the nozzle.

2. The discharge device according to claim 1, wherein a focal point of the light by the lens is positioned on a side opposite to the light source with respect to the nozzle.

3. The discharge device according to claim 1, further comprising a light emission head in which the light source is housed,
wherein an emission port of the light in the light emission head is immersed in the photocurable material housed in the housing.

4. The discharge device according to claim 1, further comprising a light emission head in which the light source is housed,
wherein
a transmissive material that transmits the light is disposed between an emission port of the light in the light emission head and the photocurable material housed in the housing, and
the transmissive material covers a surface of the photocurable material housed in the housing, the surface facing the emission port.

5. The discharge device according to claim 1, wherein
the nozzle is provided in a lower wall of the housing, and
the light source is disposed above the nozzle.

6. A discharge method using the discharge device according to claim 1, comprising emitting the light from the nozzle through the photocurable material housed in the housing while focusing the light with the lens while discharging the photocurable material from the nozzle.

7. The discharge method according to claim 6, wherein the photocurable material is cured by multi-photon absorption of the light at a focal point by the lens.

8. The discharge method according to claim 6, wherein an optical transmission line is formed on a substrate by the photocurable material discharged from the nozzle.
